(19) United States
(12) Patent Application Publication
(10) Pub. No.: US 2010/0148105 A1
(43) Pub. Date: Jun. 17, 2010

(54) SECURITY MECHANISM FOR A FLOW CONTROL DEVICE ON A RAILCAR AND METHOD OF COUPLING THE SAME

(76) Inventors: Christopher Reckker, O'Fallon, MO (US); Gerald W. Ohmes, Wentzville, MO (US)

Correspondence Address: Patent Docket Department;Armstrong Teasdale LLP, One Metropolitan Square, Suite 2600, St. Louis, MO, 63102-2740, US

(21) Appl. No.: 12/711,801

(22) Filed: Feb. 24, 2010

Related U.S. Application Data
(63) Continuation-in-part of application No. 12/170,052, filed on Jul. 9, 2008.

(51) Int. Cl. F16K 31/00; B23P 11/00

(52) U.S. Cl. 251/293; 29/428

(57) ABSTRACT

A security mechanism for a flow control device on a railcar and method of coupling the security mechanism to the flow control device are provided. A support member is coupled to the railcar. An extension handle has a first end operatively coupled to the flow control device on the railcar. An opposing second end of the extension handle forms a handle member. The extension handle is slidably coupled to the support member. A securement member is provided for coupling the support member to the extension handle to prohibit movement of the extension handle relative to the support member. The securement member is coupled to the extension handle proximate to the second end.

### CROSS REFERENCE TO RELATED APPLICATIONS

This application is a continuation-in-part of U.S. patent application Ser. No. 12/170,052, filed Jul. 9, 2008, entitled “A Valve Extension Handle and Method of Using The Same,” which is hereby incorporated by reference in its entirety.

### BACKGROUND OF THE INVENTION

The field of the disclosure relates generally to flow control valves and, more particularly, to a securement member to limit movement of an extension handle for operating a flow control valve positioned on an underside of a railcar.

Railcars have long been used to store and transport liquid, powdered and granular materials. These railcars may be cylindrical or rectangular in shape and include one or more enclosed hoppers that facilitate securely and efficiently transporting the materials to a destination while minimizing material loss during transport.

In at least some known railcars, the materials contained within the railcars are discharged from the railcar using a pneumatic discharge system. In order to discharge the materials from the railcar, air is fed into the railcar hopper from an external source to pressurize an internal volume of the hopper. With the internal volume of the hopper pressurized, the pneumatic discharge system is utilized to unload the material from within the hopper. The pneumatic discharge system includes a network of material transfer lines or pipes and operatively coupled flow control valves for releasing a pressurized stream of material from within the hopper to discharge the material from within the hopper.

At least some known railcars include security seals that are directly attached to a flow control valve mounted on the railcar after the railcar is loaded with material and the valve is placed in a closed position. These railcars often use security seals to preserve the integrity of the contents of the one or more enclosed hoppers. These security seals must be either removed or irreparably damaged in order to open the flow control valves. Thus, these security seals may indicate whether someone has attempted to open or has opened the flow control valve.

Unfortunately, with respect to these known railcars, the network of transfer lines or pipes, and flow control valves and corresponding security seals are disposed beneath the railcar and are coupled to the underside of the railcar such that an operator of the railcar must maneuver beneath the railcar to manually apply and/or remove the security seal to open one or more of the flow control valves to release the material from within the hopper.

Accordingly, it would be desirable to provide a means for opening a control valve coupled to a railcar that allowed an operator to open the valve without having to climb underneath the railcar. It would also be desirable to have a security seal associated with the control valve that is positioned such that the operator can evaluate and remove the security seal without having to climb underneath the railcar.

### BRIEF DESCRIPTION OF THE INVENTION

In one aspect, a security mechanism for a flow control device on a railcar is provided. The security mechanism includes a support member coupled to the railcar. An extension handle has a first end operatively coupled to the flow control device on the railcar and an opposing second end forms a handle member. The extension handle is slidably coupled to the support member. A securement member couples the support member to the extension handle to prohibit movement of the extension handle relative to the support member. The securement member is coupled to the extension handle proximate to the second end.

In another aspect, a method for coupling a security mechanism to a flow control device on a railcar is provided. The method comprises coupling a first end of an extension handle to the flow control device on the railcar, forming an opening in a support member coupled to the railcar, wherein the opening is sized to receive at least a first end of a securement member, and slidably coupling a second end of the extension handle to the support member, wherein the second end of the extension handle is configured for coupling to at least a second end of the securement member.

In yet another aspect, a method for coupling a support member and an extension handle in a security mechanism for a flow control device on a railcar is provided. The security mechanism includes a securement member, the support member, and the extension handle having a first end and an opposing second end, the first end operatively coupled to the flow control device on the railcar, the extension handle slidably coupled to the support member. The method comprises inserting at least a first end of the securement member through an opening in the support member, inserting at least a second end of the securement member through a coupling member attached to the second end of the extension handle, and coupling the first end of the securement member to the second end of the securement member to couple the support member and the extension handle and prohibit movement of the extension handle relative to the support member.

### BRIEF DESCRIPTION OF THE DRAWINGS

FIG. 1 is a top view of a valve system having an extension handle in accordance with one embodiment of the present invention;

FIG. 2 is a front view of the valve system shown in FIG. 1;

FIG. 3 is a side view of the valve system shown in FIG. 1;

FIG. 4 is a front perspective view of a butterfly valve;

FIG. 5 is a top view of the extension handle of the valve system shown in FIG. 1;

FIG. 6 is a side view of the extension handle shown in FIG. 5;

FIG. 7 is a side view of a railcar with a material discharge system including a valve system without the extension handle;

FIG. 8 is a top view of an alternative embodiment of the valve system having an extension handle and a security mechanism in accordance with one embodiment of the present invention;

FIG. 9 is a front view of the alternative embodiment of the valve system with security mechanism shown in FIG. 8;

FIG. 9A is an enlarged portion of the alternative embodiment of the valve system with security mechanism shown in FIG. 9;

FIG. 10 is a side view of the alternative embodiment of the valve system with security mechanism shown in FIG. 8;

FIG. 11 is an enlarged portion of the alternative embodiment of the valve system with security mechanism shown in FIG. 10;

FIG. 12 is a top view of the extension handle of the alternative embodiment of the valve system with security mechanism shown in FIG. 8;

FIG. 13 is a side view of the extension handle shown in FIG. 12; and

FIG. 14 is a side view of an exemplary securement member used with the alternative embodiment of the valve system with security mechanism.

### DETAILED DESCRIPTION OF THE INVENTION

The present disclosure describes a valve system including a flow control device operatively coupled to a pipe in material flow communication with a hopper of a railcar. More specifically, the pipe defines a passage in material flow communication with a volume defined within the railcar hopper. The material is moved through the pipe passage to transfer the material from within the hopper into a suitable container for further transport and/or storage. The material transported within the railcar hopper includes powdered, granular or liquid material. An extension handle is operatively coupled to the flow control device to operate or control the flow control device. The extension handle extends laterally outward from the underside of the railcar and through a support member coupled to a side sill of the railcar to allow an operator to open and close a valve of the flow control device while standing next to the railcar and without having to crawl and/or reach under the railcar. Further, existing valve systems can be retrofitted to include the extension handle and the support member. During the retrofitting process, a conventional actuator, such as a squeeze trigger actuator, is replaced with an actuator as described herein. The support member is coupled to the railcar side sill using a suitable process, such as welding, and the extension handle is slidably positioned within an opening defined in the support member and coupled to the actuator. In one embodiment, the extension handle is removably coupled to the actuator.

The valve system and the extension handle are described below in reference to an application in connection with and operation of a pneumatic discharge system utilized to unload product or material from within a hopper of a railcar. However, it will be apparent to those skilled in the art and guided by the teachings herein provided that the disclosure is likewise applicable to any suitable system including one or more flow control valves utilized to control movement of a product or material through a pipe or piping system.

The present disclosure also describes an alternative embodiment of the valve system that includes an extension handle and a security mechanism coupled thereto. Specifically, the security mechanism includes a coupling member attached to the extension handle, an opening within the support member proximate to the coupling member, and a securement member that extends through the coupling member and the support member opening when the valve is in the closed position for indicating that the valve is closed and has not been tampered with. Thus, in this alternative embodiment, the extension handle is coupled to a valve system including a flow control device operatively coupled to a pipe in material flow communication with a hopper of a railcar. The extension handle extends laterally outward from the underside of the railcar and through a support member coupled to a side sill of the railcar. A securement member extends through the support member opening and the extension handle coupling member to restrict movement therebetween, and likewise restrict movement of the flow control device. An operator is thus able to apply and later remove the securement member while standing next to the railcar and without having to crawl and/or reach under the railcar.

As used herein, references to “material flow” are to be understood to refer to a movement of material, such as a liquid, a gas, or a solid material or product, for example from within a container configured to contain the material and into and through a pipe or piping system configured to facilitate removing the material from within the container.

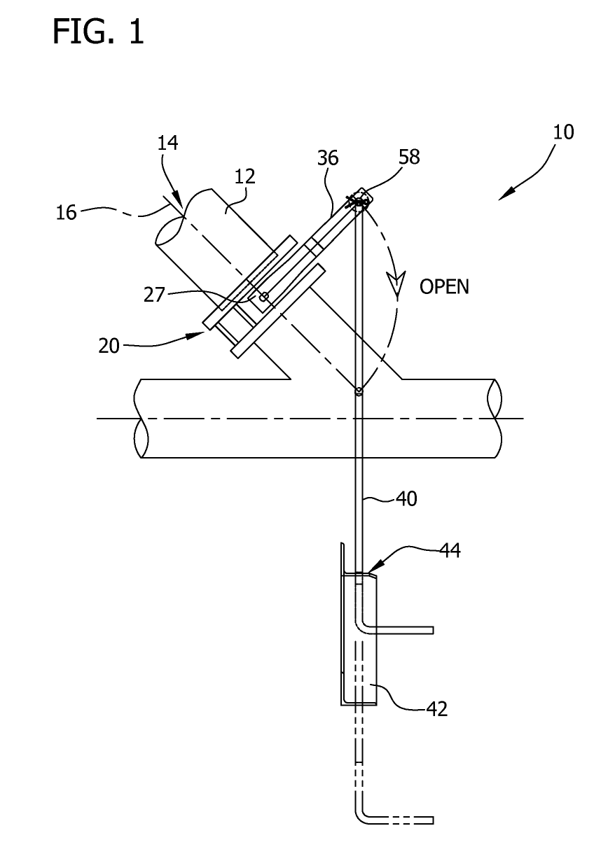

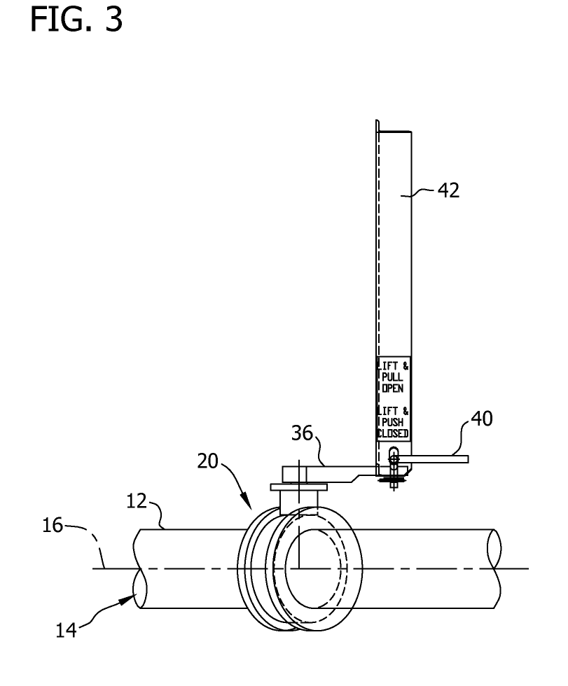

Referring to FIGS. 1-6, in one embodiment, a valve system 10 is operatively coupled to a material discharge system of a railcar configured to move material from within one or more hoppers of the railcar into a suitable container. The hopper defines a volume suitable for containing a material during transport. The discharge system includes one or more pipes 12 coupled to an underside of the railcar to facilitate transferring the material. Pipe 12 defines a passage 14 having a central axis 16. Passage 14, also referred to as a first passage or a pipe passage, is in material flow communication with the volume of the hopper to allow movement or flow of the material through pipe 12. Valve system 10 includes a flow control device 20 operatively coupled to pipe 12.

In one embodiment, flow control device 20 includes a body that defines a passage and a valve that is movably positioned within the body passage. This passage through the body of device 20 is sometimes referred to as the body passage or the second passage. The valve is movable between an open position allowing material flow through the body passage and a closed position limiting material flow through the body passage. An actuator is operatively coupled to the valve, and pivotally movably with respect to the body to move the valve between the open position and the closed position.

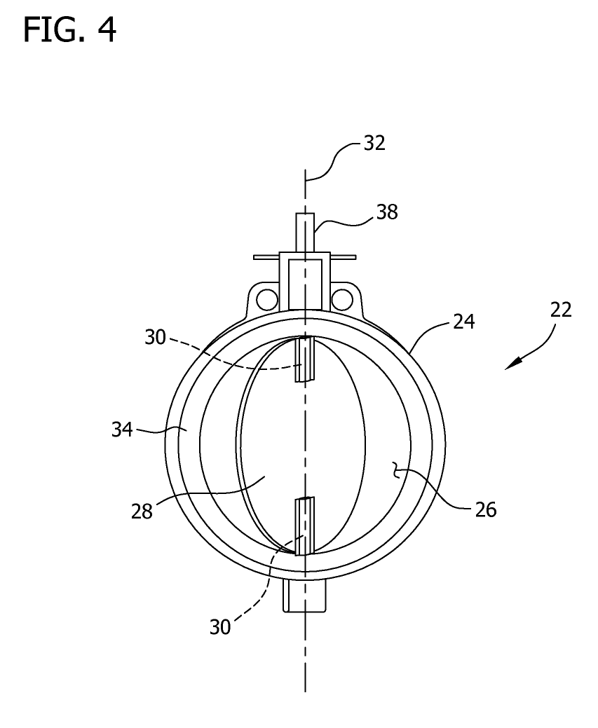

Referring further to FIG. 4, in one embodiment, flow control device 20 includes a butterfly valve 22. Butterfly valve 22 includes a body 24 that defines a passage 26 in material flow communication with passage 14 defined through pipe 12 and having a central longitudinal axis 27 aligned with central axis 16 of passage 14. A disk 28 is movably positioned within passage 26. In this embodiment, disk 28 has an elliptical surface area, such as a circular surface area, and is positioned within passage 26 to regulate a fluid flow, such as a flow of material, through a section of pipe 12. Disk 28 is rotatably coupled within passage 26 to body 24. In a particular embodiment, disk 28 is mounted on one or more pins 30 that extend along at least a portion of an axis 32 of disk 28 defining a diameter of disk 28. Pins 30 extend outwardly from disk 28 to rotatably couple disk 28 to body 24. With pins 30 rotatably positioned within a corresponding void in body 24, disk 28 is movable within passage 26 between a first or closed position limiting material flow through passage 26 and a second or open position allowing material flow through passage 26. In the closed position, disk 28 is oriented substantially perpendicular to central axis 27 to prevent or limit material flow through passage 26. In a particular embodiment, butterfly valve 22 includes a resilient seat 34 that compresses with disk 28 in the closed position to provide a seal about a periphery of disk 28. In the open position, disk 28 is oriented substantially parallel to central axis 27 to allow material flow through passage 26. In an alternative embodiment, a rod or another suitable coupler (not shown), in lieu of pins 30, rotatably couple disk 28 to body 24.

An actuator 36 (shown in FIGS. 1-3) is coupled externally to body 24. Actuator 36 is operatively coupled to disk 28 and is pivotally movable with respect to body 24 to move disk 28 between the open position and the closed position. In one embodiment, actuator 36 is coupled to a stem 38 that is operatively coupled to disk 28, as shown in FIG. 4. Actuator 36 is pivotally movable between a first position corresponding to the closed position of disk 28 and a second position corresponding to the open position of disk 28. In the first position, actuator 36 is oriented substantially perpendicular to central axis 27 and, in the open position, actuator 36 is oriented substantially parallel to central axis 27. In this embodiment, actuator 36 is turned one quarter turn to rotate disk 28 90° between the open position and the closed position.

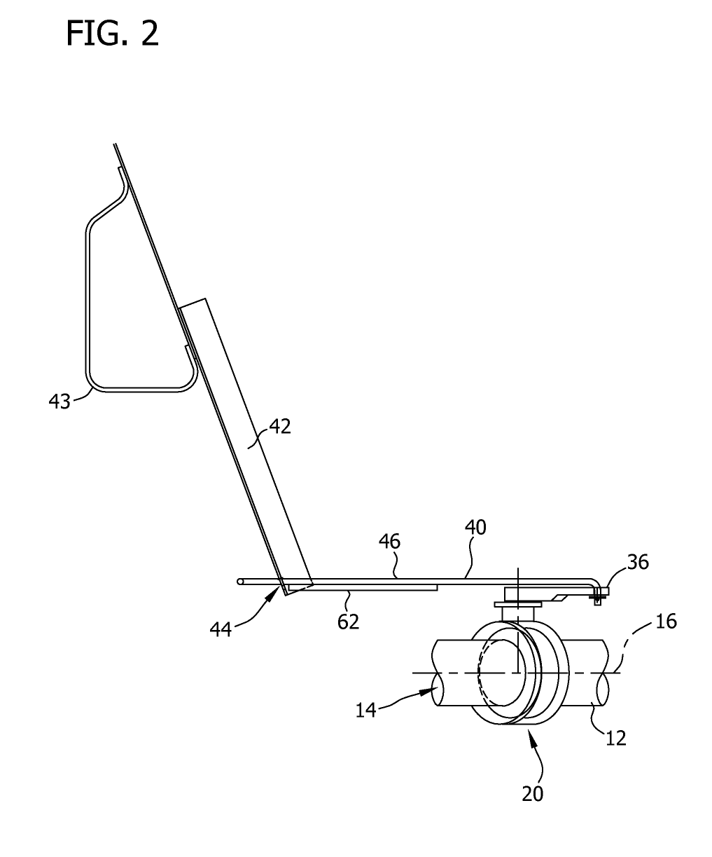

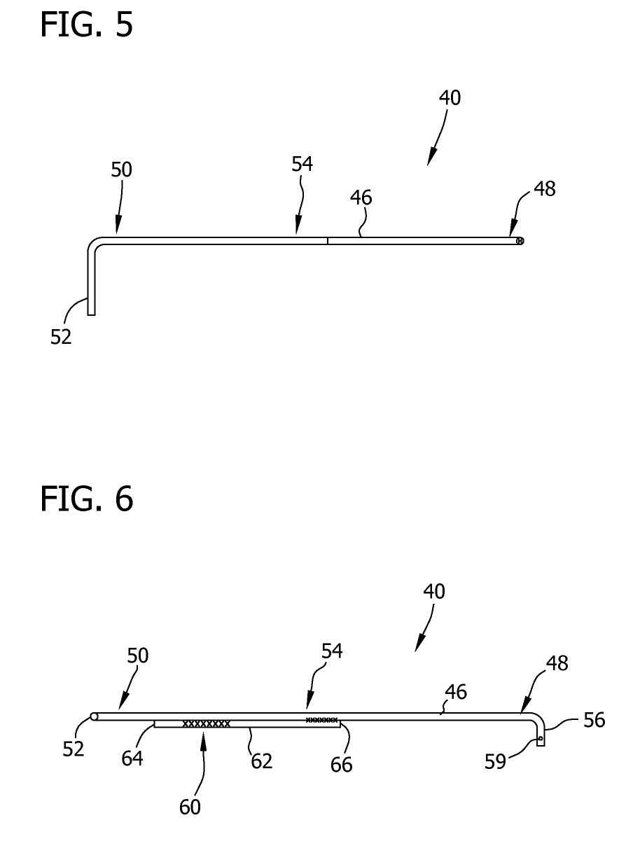

Valve system 10 includes an extension handle 40 coupled to flow control device 20. A support member 42 is coupled to the railcar, such as to a side sill 43 of the railcar shown in phantom lines in FIG. 2, to support extension handle 40. In one embodiment, support member 42 defines an opening 44 through which extension handle 40 is slidably positioned. Opening 44 has suitable dimensions for receiving extension handle 40. Referring further to FIGS. 5 and 6, extension handle 40 includes a first rod 46 having a first end 48 operatively coupled to the flow control device, an opposing second end 50 forming a handle 52 to facilitate moving extension handle 40, and a midsection 54 slidably positioned within opening 44 defined through support member 42. In one embodiment, as shown in FIG. 6, first end 48 is bent or shaped to form a portion 56 that is received within opening 58 defined through actuator 36 to couple extension handle 40 to actuator 36. First end 48 further defines an aperture 59 sized to receive a pin, such as a cotter pin, or other suitable coupler to removably couple extension handle 40 to actuator 36 of flow control device 20.

In one embodiment, first end 48 of extension handle 40 is coupled to actuator 36 to move actuator 36 with respect to body 24. As shown in FIG. 2, in this embodiment, at least a portion of first rod 46 is positioned within a first plane parallel to a second plane within which actuator 36 is pivotally movable. First rod 46 is movable within the first plane to move actuator 36 within the second plane. Referring further to FIG. 2, the first plane and the second plane are generally horizontal such that extension handle 40 extends laterally outward from the underside of the railcar to facilitate operating actuator 36 without the operator having to crawl and/or reach underneath the railcar. Extension handle 40 is translationally movable with respect to support member 42 in a lateral direction within the first plane to pivotally move actuator 36 between the first position and the second position to close and open disk 28, respectively.

As shown in FIG. 6, in one embodiment, extension handle 40 includes a locking member 60 configured to lock or secure extension handle 40 to support member 42 with disk 28 in the open position or the closed position, as desired. Locking member 60 facilitates retaining disk 28 in the closed position during transport of the material between locations and in the open position during transfer of the material from the hopper into a suitable container for further transport and/or storage. More specifically, locking member 60 prevents or limits undesirable movement of valve 28 between the closed position and the open position due to movement and/or vibration of the railcar and/or the material discharge system components. Locking member 60 includes a second rod 62 that is coupled to midsection 54 of first rod 46. A first end 64 of second rod 62 interferes with support member 42 with disk 28 in the closed position and an opposing second end 66 of second rod 62 interferes with support member 42 with disk 28 in the open position. Second rod 62 has any suitable dimensions provided that second rod 62 is slidably positionable with first rod 46 within opening 44 of support member 42.

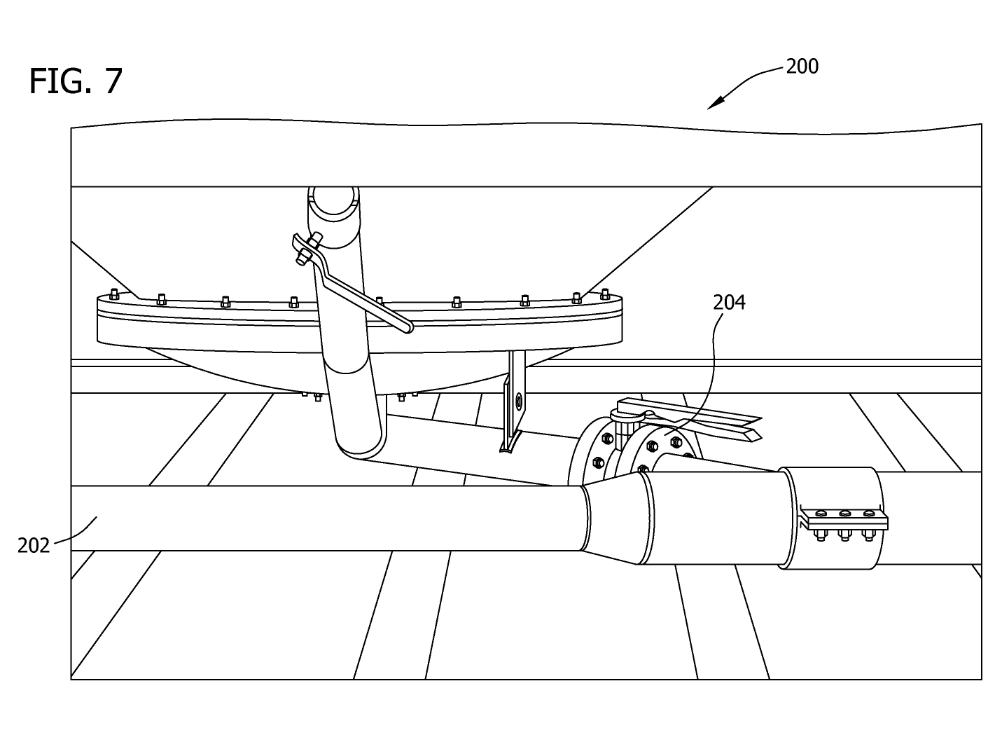

FIG. 7 is a side view of a railcar 200 with a material discharge system 202 that includes a valve system 204 without the extension handle being shown.

In one embodiment, a method for coupling an extension handle to a valve system of a railcar is provided. The railcar includes one or more hoppers each defining a volume for containing a material. The railcar also includes a material discharge system that includes one or more pipes defining a passage in material flow communication with the volume. A flow control device is operatively coupled to the pipe and includes a body defining a passage. A valve is movably positioned within the body passage. The valve is movable between an open position allowing material flow through the body passage and a closed position preventing or limiting fluid flow through the body passage. An actuator is operatively coupled to the valve and is pivotally movably with respect to the body to move the valve between the open position and the closed position. An extension handle is coupled to the actuator to pivotally move the actuator with respect to the body.

In a further embodiment, a method for coupling a valve system to a railcar is provided. The railcar includes one or more hoppers each defining a volume for containing a material. The railcar includes a material discharge system that includes one or more pipes defining a passage in material flow communication with the volume. A flow control device is operatively coupled to the pipe. The flow control device includes a body that defines a passage. A valve is movably positioned within the body passage and is movable between an open position allowing material flow through the body passage and a closed position limiting fluid flow through the body passage. An actuator is operatively coupled to the valve. The actuator is pivotally movably with respect to the body to move the valve between the open position and the closed position. An extension handle is coupled to the actuator to pivotally move the actuator with respect to the body. In a particular embodiment, a support member is coupled to the railcar. The support member defines an opening through which the extension handle is slidably positioned.

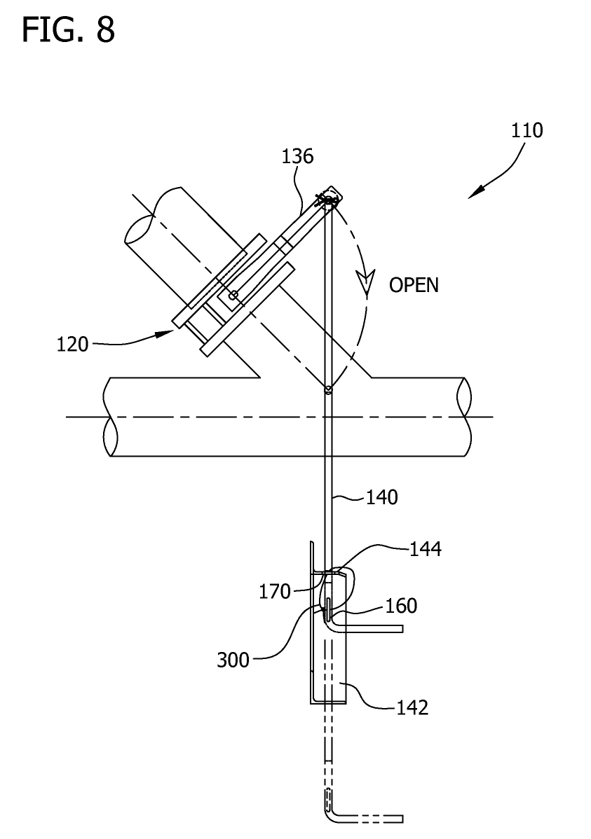

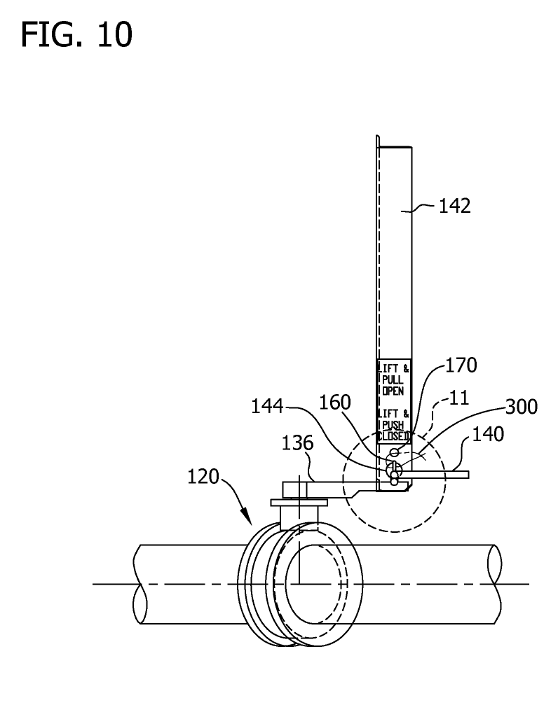

Referring now to FIGS. 8-14, another embodiment of a railcar with a material discharge system including a valve system is shown. The valve system functions the same as or substantially similar to the valve system 10 described above (shown in FIGS. 1-7). The embodiments described below differ primarily from those previously described in that a securement member is used to limit the movement of the extension handle with respect to the support member. Accordingly, the embodiments described below may be used with the embodiments described above in relation to FIGS. 1-7. However, it should be understood that the below-described embodiments may be used with any suitable valve and/or handle.

The below-described embodiments include an extension handle coupled to a valve system that includes a flow control device operatively coupled to a pipe in material flow communication with a hopper of a railcar. The extension handle extends laterally outward from the underside of the railcar and through a support member coupled to a side sill of the railcar. A securement member is coupled to the support member and the extension handle to restrict movement therebetween, and to restrict movement of the flow control device. An operator is thus able to apply and later remove the securement member while standing beside the railcar without having to crawl and/or reach under the railcar.

Further, existing extension handles used in valve systems can be retrofitted to include the securement member. During the retrofitting process, a coupling member is coupled to the extension handle using a suitable process, such as welding, and an opening is formed in the support member using a suitable process, such as drilling or boring. The securement member is then used to couple the support member to the extension handle to restrict the movement of the extension handle, and in turn the valve system, with respect to the support member.

The valve system security mechanism described herein is used with an extension handle coupled to a pneumatic discharge system utilized for unloading product or material from within a hopper of a railcar. However, it will be apparent to those skilled in the art and guided by the teachings herein provided that the disclosure is likewise applicable to any suitable system, including one or more flow control valves, having extension handles coupled thereto to control movement of a product or material through a pipe or piping system. Moreover, the embodiments described herein may be used with any suitable system that includes one or more flow control valves having extension handles coupled thereto.

Referring to FIGS. 8-11, in one embodiment, a valve system 110 includes a valve (broadly referred to as a “flow control device”) 120 operatively coupled by a pipe to a hopper of a railcar. The valve 120 is substantially similar or the same as flow control device 20 (shown in FIGS. 1-7), described in more detail above. The hopper defines a volume suitable for containing a material during transport. In one embodiment, valve 120 is movable between an open position and a closed position. In the closed position, material flow through valve 120 is substantially limited or altogether restricted, while in the open position material flow through valve 120 is not substantially impeded. An actuator 136 is operatively coupled to valve 120 and is pivotally movable to move valve 120 between the open position and the closed position.

Valve system 110 includes an extension handle 140 coupled to valve 120. A support member 142 is coupled to the railcar, such as a side sill of the railcar, to support extension handle 140. In one embodiment, support member 142 defines an opening 144 through which extension handle is slidably positioned. Opening 144 has suitable dimensions for receiving extension handle 140.

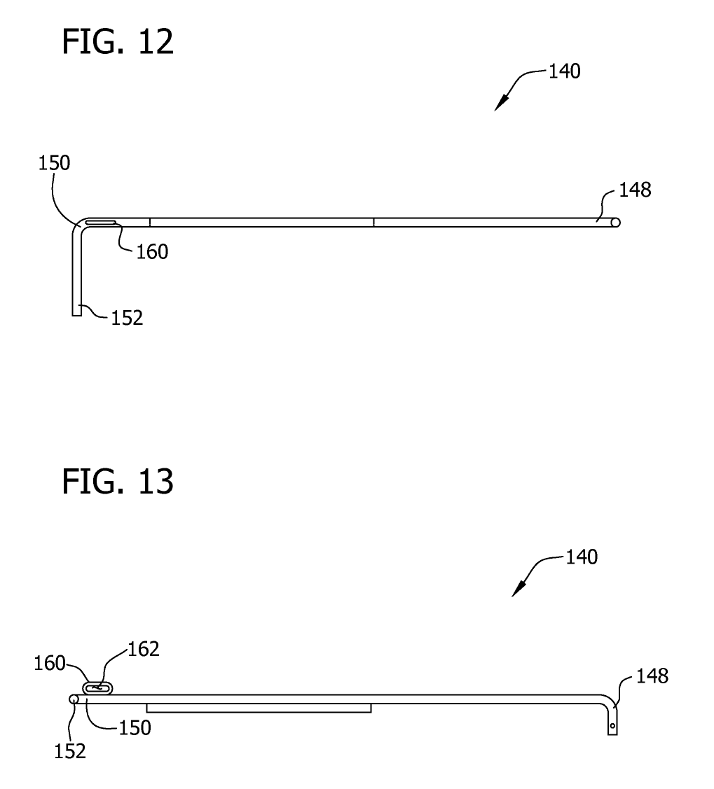

Referring now to FIGS. 12 and 13, the extension handle 140 includes a first end 148 operatively coupled to the valve 120 (shown in FIGS. 8-11) and an opposing second end 150 forming a handle 152. Handle 152 facilitates moving extension handle 140 and a portion thereof slidably positioned in opening 144 defined through support member 142. In one embodiment, as shown in FIG. 13, first end 148 is bent or shaped to define a portion that is received within an opening defined through actuator 136 to couple extension handle 140 to actuator 136.

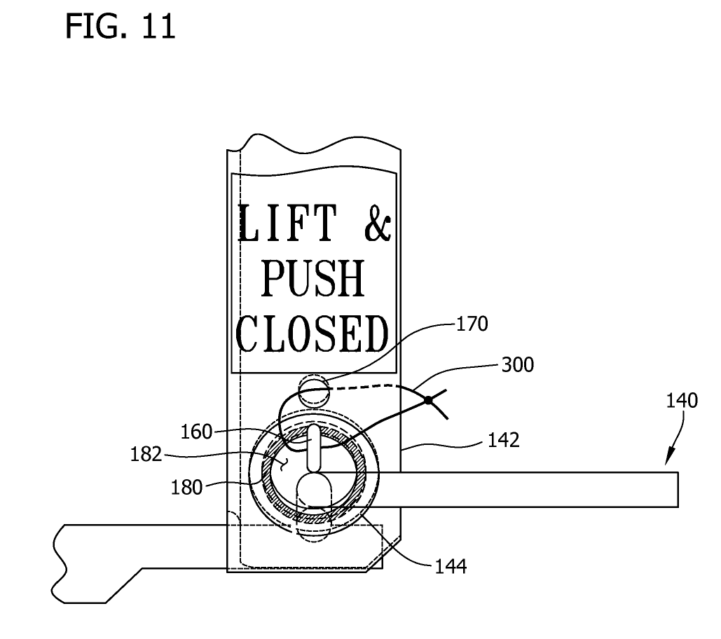

As best shown in FIG. 11, a grommet 180 is positioned along an inner circumferential edge of opening 144. Grommet 180 has a central opening 182 sized to permit extension handle 140 to be slidably positioned therein. Grommet 180 may be constructed out of any suitable material, such as rubber or plastic. Grommet 180 protects the finish and/or outer surface of the portion of the extension handle 140 that is slidably positioned in opening 144.

A coupling member 160 is coupled at or near second end 150 of extension handle 140. In one embodiment, coupling member 160 is coupled to the extension handle 140 at the handle 152 using any suitable method, such as welding or mechanical fasteners. Coupling member 160 has a central opening 162, as best seen in FIG. 13. Central opening 162 is sized to permit a securement member 300 (discussed in detail below) to pass therethrough. In the exemplary embodiment, coupling member 160 is a circular or oblong-shaped metal member, such as a link of chain. In alternative embodiments, coupling member 160 is constructed from any suitable material, such as plastic, metal, and/or composite material.

Referring now to FIG. 11, support member 142 has a support member opening 170 formed therein and positioned vertically above opening 144 and separated by a distance. Support member opening 170 is formed in support member 142 using any suitable process, such as boring, cutting, grinding, and/or drilling. Support member opening 170 is sized to receive securement member 300.

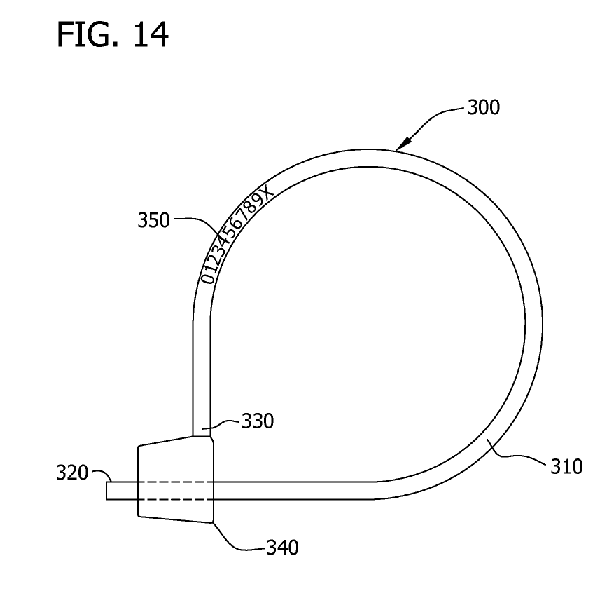

FIG. 14 shows a security seal (broadly referred to as a “securement member”) 300. In the exemplary embodiment, securement members refer to security seal 300, however a variety of different types of securement members are contemplated and the specific disclosure of security seal 300 is not intended to limit the scope of the embodiments. For example, securement member may include a mechanical locking device (e.g., a lock), one or more flexible coupling elements (e.g., a chain or a piece of wire rope) that are coupled together by the mechanical locking device, and a plastic zip-tie that locks together.

Security seal 300 includes a body 310 with a first end 320 and an opposing second end 330. Security seal 300 may be formed from any suitable material, such as plastic or metal. In the exemplary embodiment, security seal 300 is formed from a compliant plastic-like material. In other embodiments, security seal 300 is formed from a substantially rigid material. In a first, or initial, state, first end 320 and second end 330 are longitudinally spaced-apart and are not coupled together. In a second, or fastened, state, as shown in FIG. 14, first end 320 and second end 330 are coupled together.

A catch member 340 is disposed at or near second end 330. Catch member 340 is configured to couple first end 320 to second end 330. Together, body 310, first end 320, second end 330, and catch member 340 are referred to as the components of security seal 300. Catch member 340 and/or body 310 may have any one of a number of suitable structures formed therein to couple first end 320 and second end 330 together. For example, catch member 340 and body 310 may function similarly to a cable tie, wherein once a portion of body 310 (i.e., first end 320) passes through catch member 340 it may not be removed therefrom without causing damage to catch member 340.

In an alternative embodiment, first end 320 may have a barb-like profile. Catch member 340 then has a resilient, ratchet-like member disposed therein that is outwardly displaceable. Accordingly, the ratchet-like member deflects outward upon insertion therein of barb-like first end 320. After barb-like first end 320 passes through the ratchet-like member, the ratchet-like member returns to its initial state, thus preventing barb-like first end 320 from being pulled backwards through catch member 340.

Alternatively, first end 320 and second end 330 are coupled together using catch member 340 by deforming first end 320, second end 330, and/or catch member 340. First end 320 and second end 330 are placed within catch member 340 and a mechanical force is applied to any of the components such that they are deformed and coupled together. The mechanical force may be imparted in a punching and/or boring operation.

Referring again to FIG. 14, indicia 350 are disposed on body 310 and provide a visual identification mechanism. Indicia 350 provide a unique identification mechanism for security seal 300 such that out of a plurality of security seals 300, each of the plurality has different indicia 350. In the exemplary embodiment, indicia 350 includes a series of numbers and/or letters. The series of numbers and/or letters may be a unique or sequential number, such as a serial number and/or other tracking number. Moreover, indicia 350 may include letter or other characters as well. In alternative embodiments, indicia 350 includes an optical machine-readable form of data, such as a bar code. In other alternative embodiments, indicia 350 may be applied to the body 310 before and/or after the security seal 300 is in the coupled configuration.

In the coupled configuration, security seal 300 forms a substantially continuous loop of material. Once first end 320 and second end 330 are coupled together by catch member 340, they are not readily separated or otherwise uncoupled without damaging one or more of the components of security seal 300. Breaking or uncoupling security seal 300 is accomplished by cutting or otherwise severing a portion of security seal 300, thus irreparably damaging security seal 300. Accordingly, uncoupling of first end 320 from second end 330 results in irreparable damage to security seal 300. In one embodiment, a portion (e.g., a portion of body 310) of security seal 300 must be cut or otherwise torn to break the continuous loop of material.

The damage to one or more of the components of security seal 300 is readily visible by an operator. Moreover, once decoupled, security seal 300 is not able to be coupled again without showing signs of tampering. For example, after cutting of body 310 of security seal 300 to decouple first end 320 from second end 330, adhesive may be used to re-couple first end 320 and second end 330. The presence of adhesive would be readily detectable upon visual inspection by an operator.

Replacement of security seal 300 after being damaged with another, undamaged security seal is also readily detectable. Indicia 350 provide a unique identification mechanism for security seal 300. Each of a plurality of otherwise similar security seals 300 each have different indicia 350 and are therefore readily distinguishable. Accordingly, if security seal 300 is replaced with another similar security seal, the replacement security seal will be readily detectable because indicia 350 on the replacement security seal will be different from the indicia 350 on security seal 300.

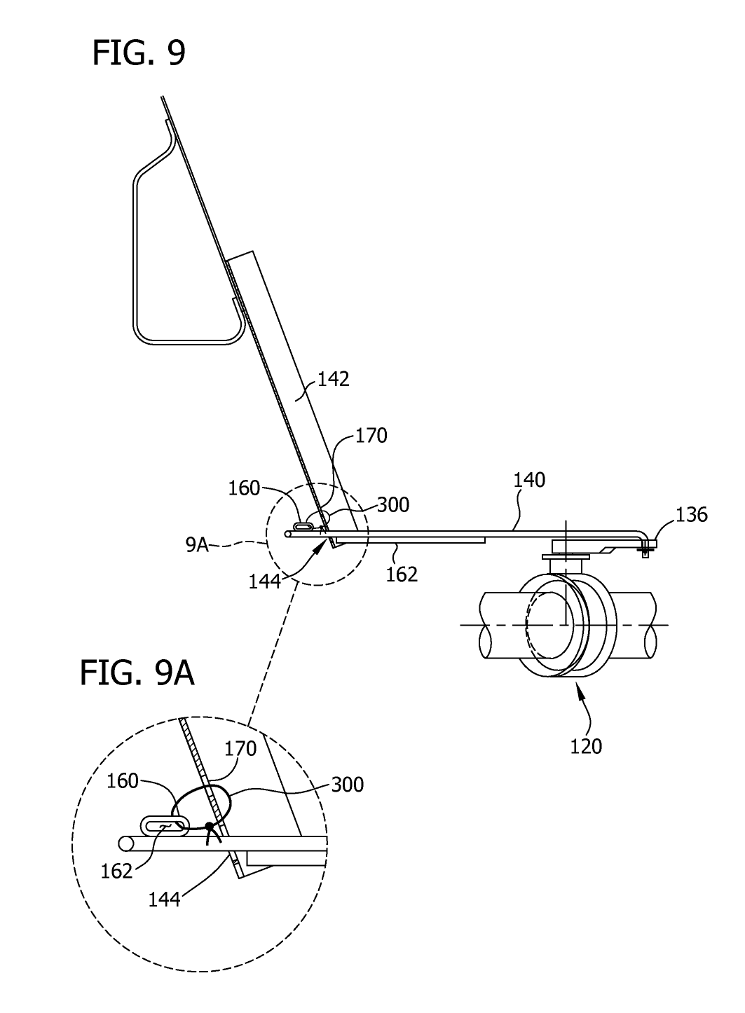

In use with valve system 110, security seal 300 is used to pass through central opening 162 of coupling member 160 and support member opening 170 in support member 142 (as shown in FIGS. 9A and 11) to couple coupling member 160 and support member 142 together upon first end 320 and second end 330 being coupled by catch member 340. In the exemplary embodiment, security seal 300 is used to couple coupling member 160 to support member 142 to restrict the movement of extension handle 140 with respect to support member 142. Restriction of the movement of extension handle 140 likewise restricts movement of actuator 136 and valve 120. Thus, security seal 300 is used to restrict movement of extension handle 140 relative to support member 142. By so doing, seal 300 prevents valve 120 from being opened unless seal 300 is removed, in which case the true operator of valve 120 will know whether the opening of valve 120 was an authorized opening or an unauthorized opening.

In operation, actuator 136 and valve 120 are placed in a closed position that substantially or altogether restricts material flow therethrough. Material is then loaded into the hopper of the railcar at an origin point. Security seal 300 is passed through support member opening 170 and central opening 162 of coupling member 160. First end 320 is then coupled to second end 330 by catch member 340. Indicia 350 are then recorded or otherwise noted for later reference (e.g., noted on a bill of lading communicated to a recipient of the railcar).

Security seal 300 thus restricts the movement of extension handle 140 with respect to support member 142, which in turn restricts movement of actuator 136 and valve 120. Accordingly, valve 120 may not be moved from the closed position to the open position without removing and/or damaging security seal 300.

Security seal 300 is removed to open valve 120 at a later time (e.g., after it has arrived at a destination point). Security seal 300 may be inspected (either before or after removal) for visual signs of damage to determine if it has been tampered with. Indicia 350 may be compared to the earlier notation of indicia 350. In embodiments using bar code form of indicia 350, a bar code scanner may be used to read indicia 350 and a suitable computer system may then compare the indicia 350 read by the bar code scanner to the earlier notation of indicia 350.

If security seal 300 shows no signs of damage or tampering and indicia 350 are the same as those recorded at the origin point, then extension handle 140 has not been moved during transit of the railcar and valve 120 has remained in the closed position since security seal 300 was first applied. However, if security seal 300 shows sign of damage or tampering and/or indicia 350 are not the same as those recorded at the origin point, then it is possible that extension handle 140 has been moved during transit of the railcar and valve 120 may have been moved to the open position since security seal 300 was first applied.

In one embodiment, a method for coupling a security mechanism to a flow control device on a railcar is provided. The method comprises coupling a first end of an extension handle to the flow control device on the railcar, forming an opening in a support member coupled to the railcar, wherein the opening is sized to receive at least a first end of a securement member, and slidably coupling a second end of the extension handle to the support member, wherein the second end of the extension handle is configured for coupling to at least a second end of the securement member.

In another embodiment, a method for coupling a support member and an extension handle in a security mechanism for a flow control device on a railcar is provided. The security mechanism includes a securement member, the support member, and the extension handle having a first end and an opposing second end. The first end is operatively coupled to the flow control device on the railcar and the extension handle is slidably coupled to the support member. The method comprises inserting at least a first end of the securement member through an opening in the support member, inserting at least a second end of the securement member through a coupling member attached to the second end of the extension handle, and coupling the first end of the securement member to the second end of the securement member to couple the support member and the extension handle and prohibit movement of the extension handle relative to the support member.

The above-described valve system and extension handle allows an operator to operate or control a flow control device of a material discharge system without having to crawl and/or reach under a railcar. More specifically, the extension handle facilitates moving a valve of the flow control device between a closed position to prevent material flow through the flow control device and an open position allowing material flow through the flow control device to facilitate transferring the material from within the hopper to a suitable container for further transport and/or storage. Because the extension handle extends laterally outward from underneath the railcar, the operator is able to control the fluid control device while standing on a side of the railcar and without having to crawl and/or reach under the railcar, thus, allowing the operator to safely and efficiently control material flow through the material discharge system of the railcar. Further, the support member of the valve system is coupled to the side sill of the railcar, for example, to support the extension handle in a generally horizontal plane to facilitate operating the actuator of the flow control device to move the valve between the open position and the closed position, as desired.

The above-described valve system security mechanism allows an operator to apply and remove securement members to a flow control device of a material discharge system without having to crawl and/or reach under a railcar. More specifically, the placement of a securement member is used to couple an extension handle coupled to a valve of the flow control device to a support member coupled to the railcar. Because the extension handle extends laterally outward from underneath the railcar, the operator is able to apply and remove the securement member while standing on a side of the railcar and without having to crawl and/or reach under the railcar, thus, allowing the operator to safely and efficiently apply and remove securement members.

Exemplary embodiments of a method and system for controlling material flow through a material discharge system are described above in detail. The method and system are not limited to the specific embodiments described herein, but rather, steps of the method and/or components of the system may be utilized independently and separately from other steps and/or components described herein. Further, the described method steps and/or system components can also be defined in, or used in combination with, other methods and/or systems, and are not limited to practice with only the method and system as described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A security mechanism for a flow control device on a railcar, the security mechanism comprising:
a support member coupled to the railcar;
an extension handle having a first end operatively coupled to the flow control device on the railcar and an opposing second end forming a handle member, the extension handle slidably coupled to the support member; and
a securement member for coupling the support member and the extension handle to prohibit movement of the extension handle relative to the support member, wherein the securement member is coupled to the extension handle proximate to the second end.

2. A security mechanism in accordance with claim 1 wherein the support member comprises an opening formed within the support member, wherein the support member opening is sized to receive at least a portion of the securement member.

3. A security mechanism in accordance with claim 1 wherein the extension handle further comprises a coupling member attached to the second end of the extension handle, the coupling member comprising a central opening sized to receive at least a portion of the securement member.

4. A security mechanism in accordance with claim 1 wherein the support member comprises an opening formed within the support member;
the extension handle comprises a coupling member attached to the second end of the extension handle, the coupling member comprising an opening,
wherein the support member opening and the coupling member opening are sized to receive at least a portion of the securement member for restricting movement of the extension handle with respect to the support member.

5. A security mechanism in accordance with claim 4 wherein the support member is coupled to a side sill of the railcar, and the extension handle extends outwardly away from the side sill such that the handle member and the securement member are accessible by an operator standing next to the railcar.

6. A security mechanism in accordance with claim 1 wherein the securement member is a security seal comprising a first end, a second end, a flexible body extending between the first end and the second end, and a catch member located near the second end of the security seal, wherein the catch member is configured to receive and retain the first end of the security seal therein.

7. A security mechanism in accordance with claim 6 wherein the security seal has identifying indicia included thereon, wherein the identifying indicia includes at least one numeral or at least one character.

8. A security mechanism in accordance with claim 7 wherein the identifying indicia includes an optical machine-readable form of data including at least one bar code.

9. A security mechanism in accordance with claim 1 wherein the extension handle is translationally movable with respect to the support member between a first position to position the flow control device in an open position and a second position to position the flow control device in a closed position, wherein the securement member is configured to restrict movement of the extension handle when the extension handle is in the second position.

10. A method for coupling a security mechanism to a flow control device on a railcar, said method comprising:
coupling a first end of an extension handle to the flow control device on the railcar;
forming an opening in a support member coupled to the railcar, wherein the opening is sized to receive at least a first end of a securement member; and
slidably coupling a second end of the extension handle to the support member, wherein the second end of the extension handle is configured for coupling to at least a second end of the securement member.

11. A method in accordance with claim 10 further comprising inserting at least the first end of the securement member through the opening in the support member.

12. A method in accordance with claim 11 further comprising inserting at least the second end of the securement member through a coupling member attached to the second end of the extension handle.

13. A method in accordance with claim 12 further comprising coupling the first end of the securement member and the second end of the securement member to prohibit movement of the extension handle relative to the support member.

14. A method for coupling a support member and an extension handle in a security mechanism for a flow control device on a railcar, the security mechanism including a securement member, the support member, and the extension handle having a first end and an opposing second end, the first end operatively coupled to the flow control device on the railcar, the extension handle slidably coupled to the support member, said method comprising:
inserting at least a first end of the securement member through an opening in the support member;
inserting at least a second end of the securement member through a coupling member attached to the second end of the extension handle; and
coupling the first end of the securement member to the second end of the securement member to couple the support member and the extension handle and prohibit movement of the extension handle relative to the support member.

15. A method in accordance with claim 14 wherein inserting at least the second end of the securement member through the coupling member includes inserting at least the second end of the securement member through a central opening in the coupling member sized to receive at least a portion of the securement member.

16. A method in accordance with claim 14 wherein coupling the first end of the securement member to the second end of the securement member restricts movement of the extension handle with respect to the support member.

17. A method in accordance with claim 16 wherein the support member is coupled to a side sill of the railcar and the extension handle extends outwardly away from the side sill such that coupling the first end of the securement member to the second end of the securement member is performed by an operator standing next to the railcar.

18. A method in accordance with claim 14 wherein the securement member is a security seal comprising a first end, a second end, a flexible body extending between the first end and the second end, and a catch member located near the second end of the security seal, wherein the catch member is configured to receive and retain the first end of the security seal therein to couple the first end of the security seal to the second end of the security seal.

19. A method in accordance with claim 18 wherein uncoupling the first end of the security seal from the second end of the security seal damages the security seal.

20. A method in accordance with claim 14 wherein coupling the first end of the securement member to the second end of the securement member includes locking the first end and the second end of the securement member together with a lock.

21. A method in accordance with claim 18 further comprising applying identifying indicia to the security seal, wherein the identifying indicia includes at least one numeral or at least one character.

22. A method in accordance with claim 21 wherein the identifying indicia is applied to the security seal before the first end of the security seal is coupled to the second end of the security seal.

23. A method in accordance with claim 21 wherein the identifying indicia is applied to the security seal after the first end of the security is coupled to the second end of the security seal.
